(19) United States
(12) Patent Application Publication
(10) Pub. No.: US 2011/0289537 A1
(43) Pub. Date: Nov. 24, 2011

(54) TEMPORARY AUTHORIZATION FOR A USER DEVICE TO REMOTELY ACCESS A VIDEO ON-DEMAND SERVICE

(76) Inventor: Joe Buehl, Studio City, CA (US)

(21) Appl. No.: 12/785,724

(22) Filed: May 24, 2010

(51) Int. Cl. H04N 7/173

(52) U.S. Cl. 725/98

(57) ABSTRACT

A remote access to video on-demand (“VOD”) system provides a user with the ability to retrieve VOD content from a remote service location. The user first registers for this service and receives a mobile application downloaded to a mobile device. The user subsequently requests VOD content in one embodiment by accessing a web site, identifying themselves and the requested VOD content. The system provides a visual token to the user, where the mobile device uses the camera function to transmit a corresponding token value to a remote access VOD server. Upon determining the values correlated, the system provides the requested VOD content in accordance with the user's subscription profile for receiving VOD services. A remote access server in one embodiment provides the mobile application download, receives the request; generated the visual token, receives the response, and causes the selected VOD program to be streamed.

### FIELD OF INVENTION

This invention generally pertains to systems and methods allowing a cable service subscriber to use a device, such as a laptop computer, to remotely access content in a video on-demand system available to the cable subscriber using a set top box.

### BACKGROUND OF THE INVENTION

Television viewers have become more sophisticated in their viewing habits over the past decades. In the past, viewers were only able to only view a television program as it was broadcasted to them. To remedy the limitation of viewers having to adjust their schedules to coincide with television broadcast schedules, video service providers, such as cable service providers (“CSPs”) developed services such as video on-demand (“VOD”). VOD allows viewers to determine when a movie will be viewed according to their schedule. Further, VOD typically provides the convenience of allowing a large number of titles to be selected for viewing and thus avoids the need for a cable subscriber to visit a video rental store. Thus, viewers are able to adjust when they view a movie streamed by the cable service provider, so as to accommodate their busy schedules.

However, viewers can only view a VOD movie streamed from the cable service provider at their service location, which typically is a residential location. A viewer may have several set top boxes in a house, and while it is possible for a user to select the VOD movie from any of the set top boxes in a house, the user is still limited to receiving the service at that service location.

Many viewers have hectic schedules, and may not be able to dedicate the necessary time to view an entire movie in their home. Alternatively, viewers may be remotely located from their service location (e.g., their house). This includes periods when the viewer is on vacation, engaging on business travel, or other trips. Viewers may desire to watch VOD movies at such times, but they are limited because they are not physically present in their home. Alternatively, the viewer may be in a room of their house where a set top box is not present. In either instance, the viewer is not able to enjoy the full level of entertainment that cable service providers strive to offer to their subscribers.

Some services exist on the Internet which provide limited television programming to viewers. These services provide a limited solution to the problem of making television related content available to users outside of their service location. Such services are generally available to any user having Internet access. However, the content offered by these services are typically limited and may not include the movie titles that that are offered in the cable service provider's VOD library. Thus, there exists a need for a mechanism allowing a viewer to remotely access VOD program titles that the viewer can access at their home over their cable service provider's cable distribution network.

### BRIEF SUMMARY OF THE INVENTION

In one embodiment, a system is disclosed that registers a viewer who is a subscriber of a cable service provider for remote access to the cable service provider's VOD service. Registration in this embodiment involves downloading a mobile application to the viewer's mobile device. The system can host a website that subsequently receives a request for VOD content from the viewer, where the request originates from a computer operated by the user. The system responds to request by providing a visual token to the viewer, which is displayed on the viewer's computer. The viewer uses a mobile application executing on a mobile device to capture an image of the visual token. The mobile device then sends a second token value to a predefined address using the data communication capabilities of the mobile device. The system receives the second token value, determines that the viewer is a subscriber of the cable service provider authorized to receive the request VOD program, and then causes the selected VOD program to be downloaded to the viewer's computer.

In another embodiment, a method for streaming content to a viewer is disclosed where the viewer is a subscriber of a cable service provider, and remote access to the cable service provider's VOD service is requested. In this embodiment, the steps involve receiving a request for VOD content from the viewer at a website, responding to the request by providing a visual token to the viewer, which is displayed on the viewer's computer, receiving a corresponding token value from a mobile device operated by the user, determining that the viewer is a subscriber of the cable service provider, and streaming the requested VOD content to the viewer's computer.

The above summary provides an overview of two embodiments of the invention, and is not intended to otherwise limit the scope of the claims of the invention.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates one embodiment of the system architecture for providing remote access to VOD programming,

FIG. 2 illustrates one embodiment of a viewer registering for subsequent requests for remote access to VOD programming,

FIG. 3 illustrates one embodiment of a viewer requesting remote access to a VOD program,

FIG. 4a-b illustrates one embodiment of the processing in the VOD remote access module for providing remote access to a VOD program,

FIG. 5 illustrates one embodiment of a VOD remote access system, and

FIG. 6 illustrates one embodiment of the visual token used in providing VOD remote access.

### DETAILED DESCRIPTION OF THE INVENTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

Although certain methods, apparatus, systems, and articles of manufacture have been described herein, the scope of coverage of this patent is not limited thereto. To the contrary, various embodiments encompass various apparatus, systems, and articles of manufacture fairly falling within the scope of the appended claims either literally or under the doctrine of equivalents.

As should be appreciated, the embodiments may be implemented in various ways, including as methods, apparatus, systems, or computer program products. Accordingly, the embodiments may take the form of an entirely hardware embodiment or an embodiment in which computing hardware, such as a processor or special purpose devices, is programmed to perform certain steps. Furthermore, the various implementations may take the form of a computer program product on a computer-readable storage medium having computer-readable program instructions embodied in the storage medium. Any suitable computer-readable storage medium may be utilized including but not limited to hard disks, CD-ROMs, optical storage devices, or magnetic storage devices.

The embodiments are described below with reference to block diagrams and flowchart illustrations of methods performed using computer hardware, apparatus, systems, and computer-readable program products. It should be understood that the block diagrams and flowchart illustrations, respectively, may be implemented in part by a processor executing computer-readable program instructions, e.g., as logical steps or operations executing on a processor in a computing system or other computing hardware components. These computer-readable program instructions are loaded onto a computer, such as a special purpose computer or other programmable data processing apparatus, to produce a specifically-configured machine, such that the instructions which execute on the computer or other programmable data processing apparatus implement the functions specified in the flowchart block or blocks.

### Service Overview

The service herein is referred to as “VOD remote access” or other similar variations (e.g., “remote access to VOD programs,” “remote access,” etc.). In general terms, the service allows a cable subscriber who has access to conventional VOD programming over a video service provider's distribution network to also have access to the same VOD programming on a remote basis. For purposes of illustration, the video service provider comprises a cable service provider (“CSP”).

“Remote” is typically made in reference to the service location the conventional VOD service offered by the CSP to the cable subscriber. Typically, the service location is the subscriber's residence and includes the various set top boxes required to receive cable services. Typically, the cable subscriber can access the conventional VOD service from any of the set top boxes in their residence. Any of these set top boxes may be considered as within the service location. Consequently, a remote location would typically be considered as anywhere outside of the service location that does not use the set top boxes to receive the VOD programming.

Thus, accessing VOD content from a remote computer could be considered as “remote” access to the VOD service. However, as will be seen, in one embodiment the “remote” service location could be a computer physically located in the subscriber's house. In this case, the “remote location” is in reference to using a non-set top box device for receiving VOD content. For illustration purposes, the invention will be described in the context of the cable subscriber remotely accessing the VOD service from a different location using a computer so as to simplify the explanation. However, this does not preclude the user from receiving VOD content form a computer in their residence.

The user of the service is frequency referred to as the “viewer,” “user,” or “subscriber.” In general, these refer to the same individual. A “user” is an individual using the remote access service, and because the individual is doing so for purposes of viewing a VOD program, the user can also be called the “viewer.” In most embodiments, this person also subscribes to cable service from the CSP, so they can also be called a “subscriber.”

The service provides remote access to the conventional VOD service. The exact details of how the conventional VOD service itself operates can vary. For example, the VOD service can offer a limited number of selections for the viewer, may utilize parental controls for governing access to program titles based on the program rating, or may involve differing service levels (a.k.a. subscription levels) for accessing premium content. In other words, each of these different versions of the VOD service can be used in conjunction with the remote access capability described herein, as the remote access feature does not limit the VOD service itself. Typically, but not necessarily, the aspects of the VOD service offered to the subscriber when accessing the service via the cable infrastructure are also provided to the subscriber when accessing the service remotely.

The remote access procedures involve various aspects for identifying and validating the user, namely ensuring that the remote access user is the subscriber that they indicate they are. One aspect the present invention is the prevention of unauthorized individuals accessing VOD content based on impersonating an authorized individual.

The remote access to VOD programming is illustrated using a cable service provider (“CSP”) which distributes content over a cable distribution network, which can be coaxial based, optical fiber based, a combination thereof, or using other technologies. However, the principles of the present invention can apply to any sort of video service provider using a variety of video distribution network technologies.

The remote access service typically provides the VOD programming content using an Internet based connection. Because of the ubiquitous accessibility to the Internet, the Internet provides a suitable transmission mechanism for transferring streamed VOD content to users outside of their normal service location. However, the principles of the present invention can be used for other types of access mechanisms, including wireless access using various well known or planned protocols for mobile devices. It is noted that in many instances, wireless protocols provide various degrees of compatibility with Internet Protocols, and hence they may be considered as providing a form of Internet access.

To use the VOD remote access service in one embodiment, the user, who typically is a CSP subscriber, must first register with the CSP for remote access. This registration can occur in various ways. In one embodiment, registration allows the CSP to know that the subscriber is authorized to remotely access the service and facilitates identification of the user. Registration also facilitate the CSP identifying a “trusted device” that sends an authorization token to the CSP. Registration typically occurs after downloading a mobile phone remote access VOD application (“mobile application”). The mobile application is involved with requesting downloading of the VOD content. The mobile application can be provided through various sources, and through various means.

In one embodiment, the trusted device is a mobile phone device, typically a so-called “smart phone” with certain capabilities, including in one embodiment, a camera function. However, other embodiments can use other types of devices. In many embodiments, the CSP “knows” of this mobile device before the remote access service is invoked, and thus the mobile device is referred to herein as a “trusted device.” In many embodiments, the trusted device is associated with the user's service profile. It is assumed that the mobile device is controlled by the user who is also a subscriber of the CSP.

In most embodiments, communication with the trusted device occurs using a conventional mobile phone data communication capability, namely text messaging service (a.k.a. SMS or short messaging service). However, in other embodiments, other forms of communication can be used, such as email communication.

After the subscriber registers for VOD remote access and identifies their trusted device, the subscriber can then remotely request access to the VOD service. Typically, this is done using a separate device capable of subsequently displaying the requested VOD movie. Hence, this device is referred herein to as the “display device.” In the embodiment described herein, the display device is typically an Internet capable computer, such as a laptop. However, in other embodiments, the display device could be a smart phone, tablet, desktop, and could even be the trusted device. However, for purposes of illustration, the display device and the trusted device are assumed to be distinct devices.

To access the remote access VOD service after the trusted device has been registered, the user will use the display device to access a web site operated by the CSP. In some embodiments, this web site could be hosted and operated by a third party as opposed to the CSP, but this does not impact the fundamental aspects of the invention. Access to the web site occurs using conventional Internet access techniques, and can be based on wireline or wireless access. Thus, any of the current or planned Internet access technologies, services, or arrangements can be used.

Once at the web site, the user will typically browse various VOD content selections, for the purpose of selecting a movie (or other program) to view. Although the invention is illustrated using by the user requesting a movie, the content of the VOD program requested can be of any type. Once the selection is made, the user then requests remote access to the program.

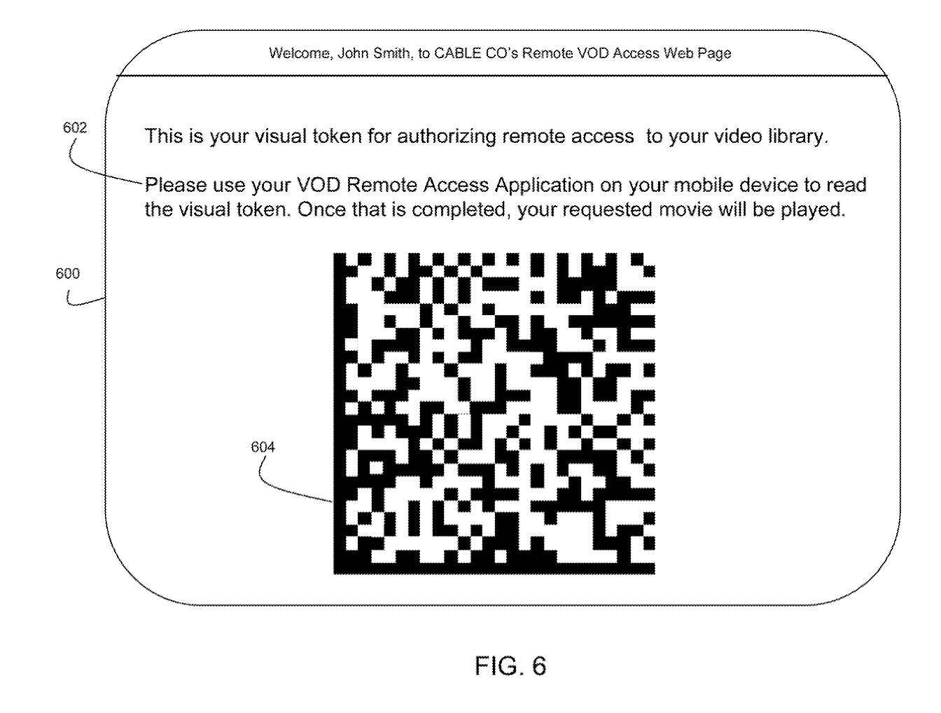

In one embodiment, after selection has been made, the user is presented with a visual token at the web site. The visual token presented on the display device can be of various forms, but typically is a bar-code image of some form. In various embodiments, various encoding methods can be used. Typically, the bar-code image is a two dimensional image, such as shown in FIG. 6. This image is displayed on the display device 600, and includes instructions 602 for the user. Typically, the viewer then uses the trusted device (the mobile smart phone) and invokes the VOD remote access mobile application (“mobile application”) to “read” the visual token on the display device. In one embodiment, the viewer takes a “picture” of the visual token, using the camera function of the trusted device, which the mobile application then processes to derive a numerical value conveyed by the visual token. The trusted device then sends this information to the remote access VOD server along with identification information of the mobile device. This typically is done using SMS or other data capability. In other embodiments, the mobile application can decrypt/encrypt the information derived from the visual token based on algorithms resident in the mobile application. Since the remote access VOD server provided the mobile application to the trusted device (or knows what processing is performed by the mobile application), the remote access VOD server knows what the corresponding algorithm (if any) that is used by the mobile application. Other public/private keys or algorithms can be used, in other embodiments. Thus, the token value sent by the trusted device can be the same or derived from the token value associated with the visual token.

When the mobile application processes the visual token and sends corresponding token information to the VOD server, the mobile application may also include various identification information. This information may include various types of identification, including a mobile device identifier, and/or “cookie” information that was previously provided to the trusted device when the mobile application was downloaded or when the user registered using the mobile application. The use of “cookies” in Internet applications are well known. A “cookie” is an alpha-numerical identifier that is deposited by the server when a device accesses a web site. The cookie can uniquely be associated in the server with a particular user. In this case, the VOD server can associate a particular cookie with a subscriber profile, and thus the server knows who the subscriber is when the server receive information from the trusted device.

Once the remote access VOD server receives the token and cookie information from the trusted device, it can use this information to ascertain that trusted device is operated by the same user making the service request from the display device (based on the token value), and further can identify the user's and associated subscription profile (based on the cookie). Thus, the VOD server can easily identify the subscriber that they claim to be and stream the selected movie in accordance with service related parameters established for that user. Once this is done, the remote access VOD server then streams the requested movie to the display device.

There are a number of variations that are possible. In one embodiment, the VOD Server generates a token value which is transmitted to the display device and displayed as a numerical value (as opposed to a visual token). The user is then instructed to enter this token value into the mobile phone application, and the mobile phone application then transmits the number back to the VOD server. In this manner, the token value is communicated from the VOD server, to the user's display device, and then from the mobile device to the VOD Server. Thus, the “visual token” that is displayed to the user can be a graphical image, or a numerical image. In other applications, the user can merely manually text the token value shown on the display device to a specified address using the mobile device. Thus, a mobile application is not required in all embodiments of the invention.

In other embodiments, the user could identify themselves at the web site, such as by entering their name, address, account number, etc. Once the VOD server has identified the user, the VOD server would identify the user's subscriber profile. The VOD Server could then send the token code to an address stored in the subscriber's profile, which would correspond to the user's mobile device. The user would then receive and view the token code at their mobile device, and could manually enter the token code into the web site. In this manner, the VOD Server could generate the token value, transmit it to the mobile device, and then the user could enter it into the web site, which is received by the VOD Server. Other variations are possible in which the user is presented with a token code at a web site, and the VOD server receives the token code manually entered by the user.

### Network Architecture

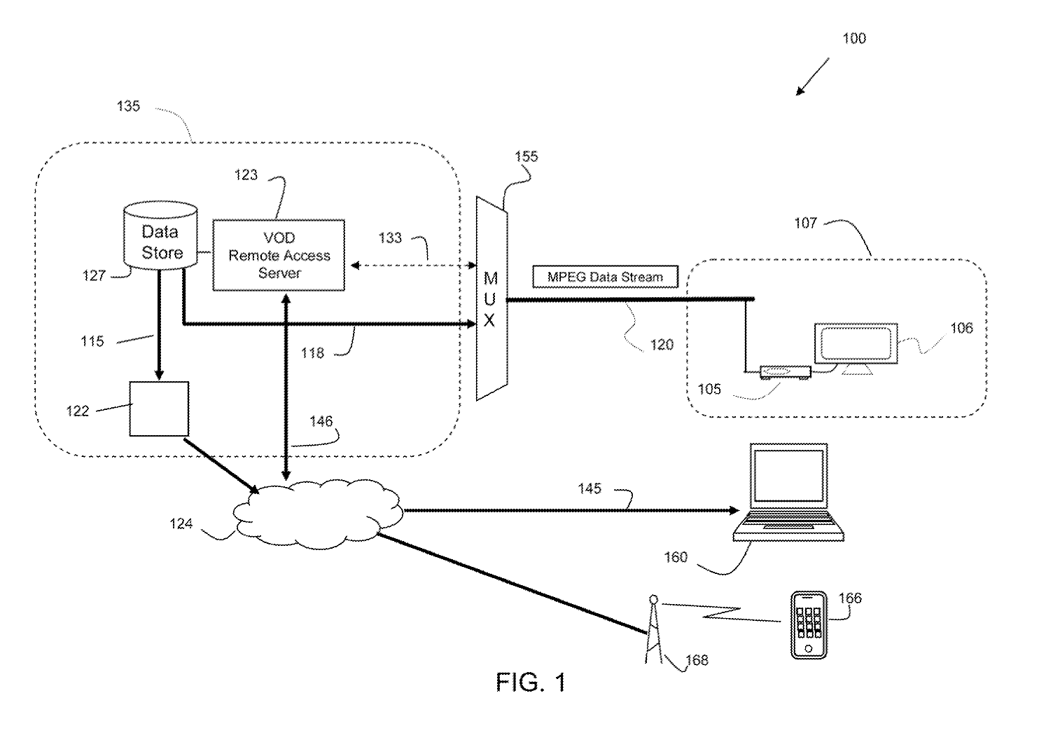

One embodiment 100 of the network architecture for providing the remote access VOD service is shown in FIG. 1. In FIG. 1, the system comprises a remote access VOD system 135 which interfaces with a multiplexer 155 of a cable service provider. The multiplexor provides digital video signals in the form of MPEG based programming over a cable distribution network 120 to a viewer's service location 107. The service location 107 is typically the subscriber's house, and typically comprises at least one set top box 105 and television 106. In other embodiments, there may be a plurality of set top boxes and televisions in the same service location. As noted before, other embodiments may incorporate other types of service providers, which have distinct network architectures.

The remote access VOD system 135 comprises a data store 127. In one embodiment, the data store is a database that stores the VOD titles and any subscriber specific data in a subscriber profile as required by the service. The data store can comprises various types of memory, including hard drives, flash memory, etc. The VOD remote access server 123 comprises a processor(s) that executes stored programming for accomplishing the steps necessary for the service operation and accesses the data store as required. The VOD remote access server 123 can communicate with the set top box 105 as indicated by the dotted line 133, which is conveyed over the cable distribution network 120. The dotted line signifies control information, and does not include movie data itself (e.g., the streaming digital video signals).

The data store 127 is shown as capable of streaming out VOD movie data to two destinations. In the first case, the VOD movie data is streamed via line 118 to the multiplexor 155 to the set top box. This is typical of the path when the user is invoking the conventional VOD service from their service location. In the second case, the VOD data store can stream data via line 115 to a gateway 122, which then streams the movie data over the Internet 124, and to the display device 160. This is typical of the path for streaming VOD data when the user is invoking remote access to the VOD service. In other embodiments, the data may be streamed via from the data store to the server, and then to appropriate destination.

During operation of the VOD service (specifically, the conventional or non-remote version of VOD), VOD titles are periodically downloaded to the set top box by the CSP using various techniques (such as a data carousel). A user may browse, select, and then request the VOD program using the remote control, which sends control signals to the set top box 105. The set top box 105 then executes program steps for a VOD application stored in the set top box, which causes it to signal to the VOD remote access server 123, for playing the selected movie. The VOD remote access server (which is actually functioning as a conventional VOD server at this point, since the conventional VOD service is being invoked), communicates with the data store 127 to then stream the selected movie over channel 118, which the multiplexor provides on the cable distribution network. The VOD remote access server 123, also informs the set top box 105 of which channel the requested program can be found. Once the set top box tunes to the indicated channel, the viewer then sees the requested movie on the television 106.

The above is a simplified explanation of the VOD service. In other embodiments, other components, including transcoders, workflow management systems, subscription management systems, etc. are involved in ensuring that the VOD service is properly provided. The VOD service may check, for example, that a requested movie can be presented to the viewer based on subscription profile information, including rating restrictions which may prohibit a particular movie from being presented.

In other embodiments, the VOD server and the remote access VOD server may be distinct systems. For illustration of the principles of the present invention, the VOD remote access server is presumed to provide both the VOD service itself and remote access to VOD.

When the system 135 provides remote access to VOD, it does so by operating in conjunction with the gateway 122, a communications network 124 such as the Internet, which is connected to both a display device 160 and wireless service provider 168, which in turn is connected to the trusted device 166. In operation, the user is presumed to be physically in the presence of both the display device 160 and the trusted device 166. The display device may be the user's laptop, but it can also be a third party owned laptop or other display device capable of receiving an Internet based video stream (such as an Internet capable digital TV). Typically, however, the trusted device is owned by the viewer.

The user uses the display device 160 to access a web page hosted by the VOD remote access server 123. This is accomplished using communication channels 145, Internet 124, and channel 146. The user can then request the remote access service, enter the appropriate identification (if required), select a movie and request that it be downloaded to the display device.

In one embodiment, before the movie is downloaded, the VOD server must generate and transmit a token to the display device 160, and receive a corresponding token value from the trusted device. The VOD remote access server then generates a visual token, and transmits it to the user's corresponding display device 160.

The user can then invoke the mobile application resident on the mobile device 166 to capture an image of the visual token presented on the display device. This can be done by taking a picture of the image using a camera function on the mobile device. Then, the mobile application can then process the visual image to extract a numerical value that is then transmitted via the wireless infrastructure 168 to the VOD remote access server. The mobile application is programmed to interpret the visual token and to provide the corresponding token value to a predetermined address associated with the VOD remote access server. This predetermined address can be included in the mobile application. A cookie may be provided with the token value to the Server, or in a separate message. The Server receives the token value and the VOD remote access server determines the token value is correlated with the visual token, and is able to then identify the user based on the cookie (and/or other identification information that is sent from the mobile device). The VOD remote access server can then ensure that the movie selection is compatible with the user's service profile, and instruct the data store to stream the video of the selected movie, over channel 115, through the gateway 122, over the Internet 124 to the display device 160.

The system requires the trusted device be physically present to translate the visual token image into a corresponding token value. Further, in some embodiments the VOD remote access server waits a limited time after generating the visual token to receive the corresponding token values from the trusted device. If the time defined expires without receiving a corresponding token value, the request for the transaction is aborted by the Server.

While FIG. 1 illustrates one embodiment of the system components, other variations are possible which comport with the principles of the present invention. Further, in other embodiments, other configurations may be used which would be apparent to one skilled in the art. Specifically, different embodiments of display devices and trusted devices may be used, different communication configurations may be present, and different remote access system 135 architectures may be used.

### User Registration

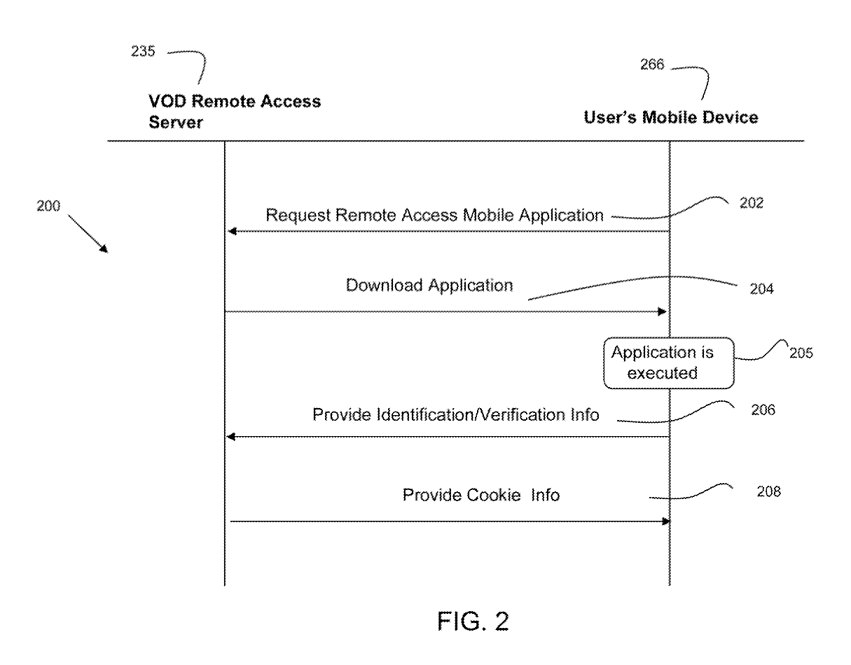

User registration refers to the procedures and steps necessary to establish the identity of the trusted device before the remote access service can be used. These procedures are illustrated in one embodiment in FIG. 2. In FIG. 2, the overall process 200 is shown using a line diagram, depicting the message flow that occurs between the VOD remote access server 235 (which corresponds to system 135 in FIG. 1) and the user's mobile device 266 (which corresponds to the trusted device 166 in FIG. 1).

The process begins with the user requesting a mobile application pertaining to the remote access to VOD service. This application can be obtained by browsing mobile applications available on-line at an “application store,” or by requesting the mobile application directly from the video service provider or a third party. In the embodiment illustrated in step 202, the mobile device requests the mobile application directly from the VOD remote access server of the CSP. In step 204, the VOD remote access server sends the application to the mobile device. In various embodiments, the mobile application could be obtained in different ways or from different sources. The application could be integrated with other capabilities and downloaded as a multi-function application. In other embodiments, the mobile application could be directed up-loaded into the phone from a connected computer or using other means.

In step 205, the mobile application is executed in the user's mobile device. Execution may occur immediately after downloading the mobile application, or at a later time. When initially executed, the execution of the mobile application typically incorporates procedures to obtain information and transmit information to the VOD remote access server. For example, the application when executed will prompt the user to provide various types of identification information, including name, address, etc.

In step 206, the mobile device provides such information as necessary to the Server. This information may include previously established account information (such as a cable service account), or the name, phone number, or other identifying information of the user. The Server uses the identification to ascertain a cable subscriber account, and depending on the type of information provided may request further verification information from the user (not shown). The purpose of this interaction is for the VOD remote access server to identify the user as a previously established subscriber, and establish links to the corresponding service profile. Different service providers may use different procedures for receiving and verifying the user's identity. In other embodiments, additional interactions can be used. For example, the Server may request the user confirm certain information, e.g., “Please confirm you are John Smith at 123 Main St.” Once the user is identified, the server may provide a cookie (if it has not already been provided). The cookie can then be linked or associated with that user's service profile so that the user can be easily identified when subsequently requesting remote access to VOD content. Typically, the remote access request is initiated from a different device, namely, the display device.

As noted, the cookie can be included when downloading the mobile application, or the Server may send the cookie separately. In one embodiment, the cookie is sent in step 208, after the mobile application has sent the identification information and the Server has ascertained which subscriber the user is. The cookie is a alpha-numerical identifier which can be subsequently used for identifying the user to the Server. Thus, subsequent communication between the Server and the mobile device may involve communicating the cookie to facilitate verification of the mobile device by the Server and/or identify prior interactions that occurred between the Server and the mobile device.

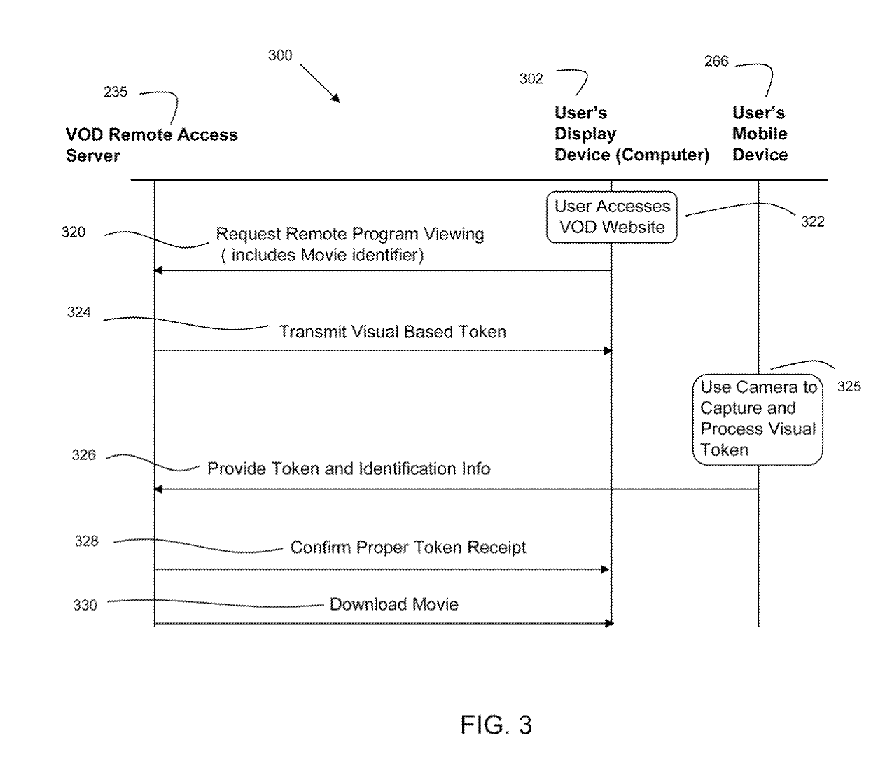

The invocation of the remote access VOD service is shown as process 300 in FIG. 3. In FIG. 3, the process 300 again is shown using a messaging line diagram. However, in this case there are two devices operated by the user: the user's display device 302 and the user's mobile device 266. In this embodiment, the user's display device 302 is a laptop computer, although other devices could be used. The device used to request the VOD remote access service is considered the “display device.”

The display device 302 is used to access a web site in step 322 in a conventional manner. The web site may be a dedicated web site for VOD services, or a general access web site of the CSP. In this embodiment, the user has browsed and selected a particular VOD program that they wish to remotely view. Consequently, a selection is made and indicated in step 320. The request typically includes an identifier of the selected movie or program desired to be viewed by the user.

The VOD Remote Access Server then generates an appropriate token internally, and uses the token to generate a visual token. The visual token may be formatted into a PDF or other bitmapped image that is transmitted to the user's display device via the web page in step 324. In some embodiments, the web page may prompt the user for identification information, and may reflect the user's identity (see, e.g., FIG. 6). The Server 235 may not necessarily know the identify of the user at this time in all embodiments. Typically the web page comprises instructions 602, and the visual token in a two-dimensional bar code image 604.

The VOD Remote Access Server may also start a timer. In one embodiment, once a token is assigned in response to a request, the token is not allocated for another user's request. Typically, the token value is a unique value that is generated for each user request. In one embodiment, the server expects receipt of the corresponding token from the user's mobile device should come within a limited time, after which the Server will consider the transaction considered aborted. In other embodiments, the Server will consider the transaction pending until the web site is closed by the user.

In this embodiment, the user is presumed to initiate step 325, wherein the user then activates the mobile application for VOD remote access. In this embodiment, the process involves using the camera function on the mobile device to capture an image of the bar code image presented on the display device. From this, the mobile application can derive the token value. The mobile application is presumed to incorporate an algorithm for decoding the visual image. In some embodiments, the mobile application may apply an additional algorithm to derive the token value, or alternately encrypt the token value. This value is then transmitted in step 326 back to the VOD remote access server 235. The communications may also include mobile device identification information and/or the cookie provided when the mobile application was previously downloaded. The identification comprising the cookie and/or mobile device identifier can be used by the VOD remote access server to ascertain the identity of the user. Thus, the Server may associate the cookie (or other information) with the user's identification information that was previously provided when registration occurred and/or with the user's service profile.

The communication from the mobile device to the Server may rely on communication abilities subscribed to by the user for the mobile device—e.g., the communication may be based on SMS (short message service, or “texting” capability). The SMS messaging may use an address for the VOD Server which is contained in the mobile application. Thus, the mobile application uses the stored destination address for transmitting the corresponding token value to the Server. Similarly, the cookie value may be transmitted from the mobile device to the server using the same electronic communication capability.

Upon receipt of the token, the VOD remote access server may confirm to the user via the display device that the token was received in step 328. This information can also instruct the user to prepare for receiving the streaming VOD movie in step 330, which was previously requested by the user via the display device.

The message interaction presented is but one embodiment of the steps involved with invoking the remote access VOD service, and other information may be transmitted or indicated with the above messages in other embodiments.

### Remote Access VOD Server Processing

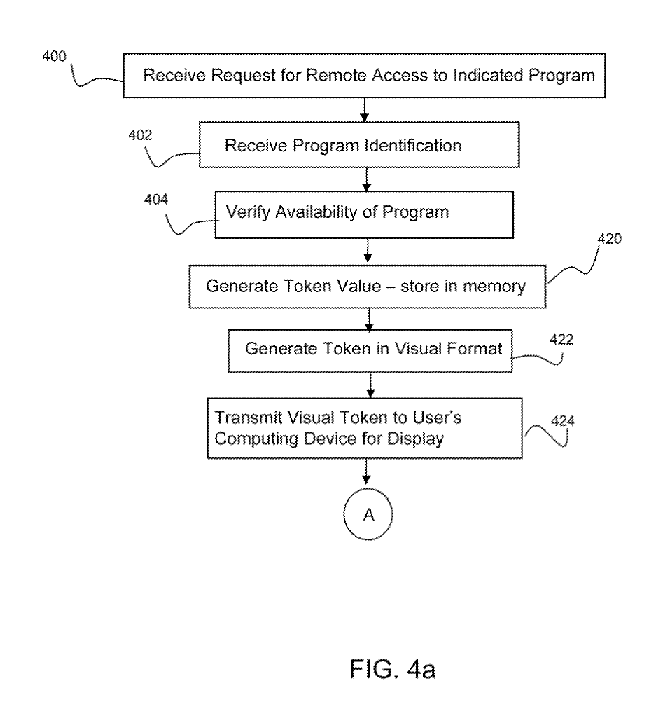

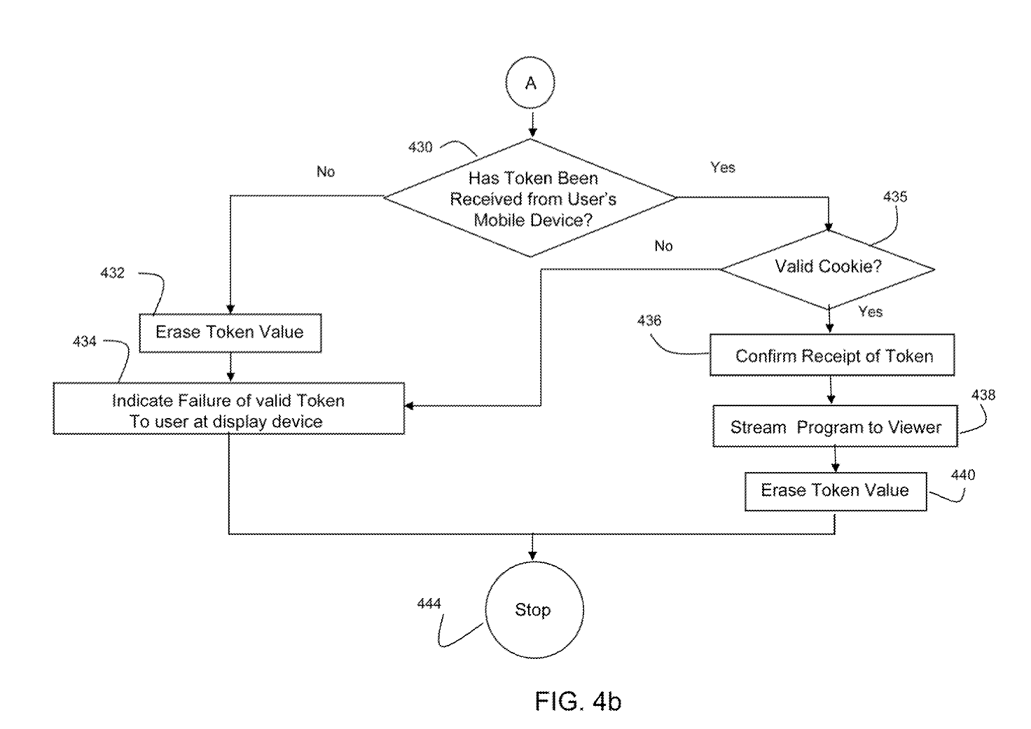

The steps involved in processing the request for the remote access service are shown in FIG. 4. Turning to FIG. 4a first, the process begins with step 400 with the Server receiving a request for remote access from the user. The user may have previously accessed a web site, or a function within a web site that is associated with requesting the service for remotely viewing a VOD movie or other type of program. The user will also indicate a particular movie for viewing in step 402. In one embodiment, the Server is step 404 confirms availability of the selected program. The Server then generates a token value in step 420. This value may be a random number, a sequentially increasing number, or a number generated through some other algorithm. In one embodiment, this number is unique and does not duplicate any other active token value. In one embodiment, this value is stored in memory, as assigned token values are tracked at least for the duration which the token value is kept active by the Server. The Server then invokes an algorithm to generate visual token data from the token value in step 422. In one embodiment, the visual token may be a two dimensional bar code represented by a PDF formatted file. Various algorithms are known for generating bar codes based on data values. In step 424, the visual token is transmitted to the display device and presented to the user via the display device. This can occur by the Server displaying the visual token on a web page, transmitting a file to the user, or any using any other approach for transferring image data to the users' display device.

The next step 430 (shown on FIG. 4b) involves the Server testing whether a corresponding token has been received back from the user's mobile device. If no value is forthcoming, then the server in one embodiment may erase the token value in step 432, and indicate the failure of a valid value in step 434.

If the mobile device does send a token value, it is typically sent by an SMS message from the mobile device and is directed to the Server using well known techniques for relaying SMS data. The process in the Server then proceeds to step 435. The value received may be the token value itself, or a value based on the token. For example, when the mobile application processes the token and transmits it to the Server, the token value send by the mobile device could be encrypted, or modified based on an algorithm known to both the Server and the mobile application. However, in other embodiments, the value send by the mobile device could be the same value. In many embodiments, the response from the user's mobile device will also include an the identifier of the trusted device, such as the aforementioned cookie that previously downloaded, a mobile device identifier, or some other value.

The Server then ascertains whether the identifier, such as the cookie, is valid in step 435. If the value is not valid, then the server indicates to the user via the display device in step 434 that an error has occurred, and the streaming of the program cannot occur. Consequently, the Server is 430 is able to ascertain if a token value has been received with a valid cookie, the Server then confirms to the user in step 436 that a valid token has been received. The service can check to see that the requested movie is compatible with the user's service profile. The Server can then begin in step 438 to stream the program to the viewer at the display device. At this point, the token value generated by the server in step 440 can be erased by the Server. This allows the value to be reused, and frees up memory in the Server. At this point, the request for remote access in step 444 can be considered as completed.

In one embodiment, once the Server generates a token in response to a request from the display device, that token value is maintained until the transaction is terminated. The Server awaits a certain time period for the user to confirm the token value. After that time window, if confirmation has not occurred, the value is erased, and the pending transaction is terminated. The remote access request is considered as aborted. In some embodiments, the process can be re-attempted, but only a limited number of times.

As is evident, the process described in FIG. 4a-b pertains to the remote accessing of the VOD program. There is another process initiated and maintained that is associated with the actual streaming of the VOD program itself. Thus, even though the remote access to VOD service is completed, the process of streaming the VOD program continues.

VOD Remote Access System

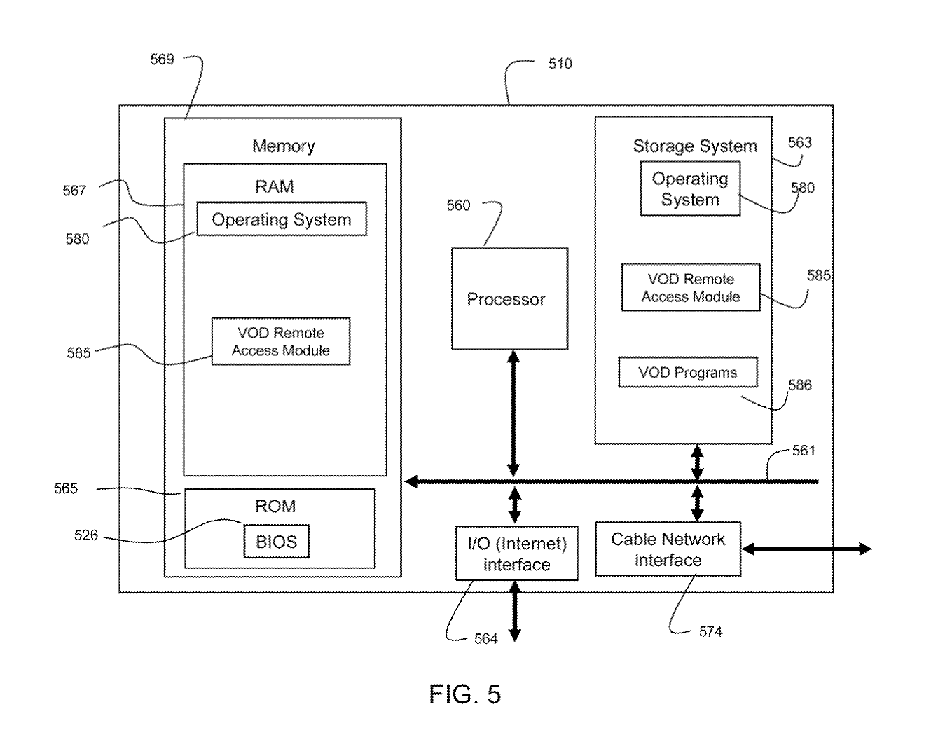

The VOD remote access system 135 of FIG. 1 comprises several elements, which include a server 123, a data store 127, and a gateway 122. One embodiment of these components is shown in FIG. 5. In FIG. 5 the system 510 is shown as comprising a processor 560, which executes software instructions. In one embodiment, these instructions may include instructions for performing the steps described in FIG. 4 and elsewhere. The processor in this embodiment performs functions associated with the VOD remote access service as well as the VOD service, but in other embodiments, distinct processors or systems may be used for these two services. The processor uses a communication bus 561 to communicate with memory 569, which can comprise both RAM 567 and ROM 565 types of memory. The RAM memory may further comprise operation system instructions 580 and the VOD Remote Access Module 585, the latter of which contains the instructions for providing the VOD remote access service. In various embodiments, the module may also provide the VOD service itself. The ROM may comprise the BIOS 526 instructions which are used upon booting up the system.

The processor also may comprise a data store in the form of a storage system 563, which may store copies of the operating system 580, the VOD remote access module 585, and VOD programs 586. The VOD programs are the movies which may be streamed to the user, either on the cable system using the cable network interface 574 or over the Internet (e.g., on a remote access basis) using the Input/Output interface 584 (e.g., gateway). The interface 564 can also be used to receive the token information from the user's trusted device, when it sends the information using a texting message service.

There are a number of configurations and/or components that can comprise system 510 that are possible, including using multiple processors, and multiple systems communicating with each other. The present invention can accommodate a variety of architectures for performing the registration and remote access service invocation aspects of the service. In some embodiments, different components can be used for registration versus service invocation. Further, different configurations are possible for the system providing remote access to VOD and the VOD service itself. Those skilled in the art will find various configurations are possible while still being within the scope of the claims.

1. A system for providing video on-demand (“VOD”) programs to a user, comprising:
a memory configured to store a token value; and
a processor configured to:
receive VOD program identification information from said user wherein said user is a subscriber of a video service provider, wherein said VOD program identification information identifies a VOD program available for viewing by said user on a video distribution network of said video service provider;
generate said token value;
store said token value in said memory;
use said token value to generate image data representing a visual token;
transmit said image data representing said visual token to a computing display device for display of said visual token to said user;
receive a second token value generated from a mobile device associated with said user, wherein said second token value is correlated with said token value;
receive an alpha-numerical identification value from said mobile device wherein said alpha-numerical identification value corresponds to previously stored alpha-numerical identification in said memory associated with said subscriber; and
cause said VOD program to be streamed to said user over a communications network that is not said video distribution network.

2. The system of claim 1 wherein said video service provider is a cable service provider and said video distribution network is a cable distribution network.

3. The system of claim 2 wherein said processor is further configured to:
store said alpha-numerical identification value in said memory prior to receiving said alpha-numerical value from said mobile device; and
use said alpha-numerical identification value to identify a subscriber profile of said subscriber.

4. The system of claim 3 further comprising:
a database storing said VOD program, said database configured to stream said VOD program; and
an interface gateway for receiving said VOD program from said database and streaming said VOD program to the Internet to said computing display device.

5. The system of claim 2 wherein said processor is configured to generate said image data representing said visual token in a two-dimensional graphical bar coded format.

6. The system of claim 2 wherein said processor is configured to generate said image data representing said visual token as numerical data.

7. The system of claim 1 wherein said processor is configured to receive a cookie as said alpha-numerical identification from the mobile device.

8. The system of claim 7 wherein the processor is configured to:
use said cookie to ascertain a subscriber profile stored in said memory; and
ascertain that a rating of said VOD program is compatible with a subscription profile of said user.

9. The system of claim 8 wherein said processor erases said token value from said memory after receiving said second token value from said mobile device.

10. A computer-readable medium comprising executable code that when executed by a processor of a computer device causes the processor to:
receive VOD program identification information from said user wherein said user is a subscriber of a cable service provider, wherein said VOD program identification information identifies a VOD program available for viewing by said user on a cable distribution network of said cable service provider;
generate a token value;
store said token value in a memory;
use said token value to generate image data representing a visual token;
transmit said image data representing said visual token to a computing display device of said user for display of said visual token to said user;
receive a second token value generated from a mobile device associated with said user, wherein said second token value is correlated with said token value;
receive an alpha-numerical identification value from said mobile device wherein said alpha-numerical identification value corresponds to previously stored alpha-numerical identification in said memory associated with said subscriber; and
cause said VOD program to be streamed to said user over a communications network that is not said cable distribution network.

11. The computer readable medium of claim 10 further comprising the step of:
storing said numerical identification value in said memory; and
using said numerical identification value to identify a subscriber profile of said subscriber.

12. The computer readable medium of claim 10 further comprising the step of:
initiating a timer associated with generating said token value, said timer having an expiration time;
receiving said second token value from said mobile device prior to expiry of said timer;
erasing said token value after receipt of said second token value; and
terminating said timer after receipt of said second token value.

13. The computer readable medium of claim 11 further comprising the step of comparing a rating indicator of said VOD program with said subscriber profile, wherein said subscriber profile indicates streaming of programs with said rating indicator is allowable.

14. A method for providing video on-demand (“VOD”) programs to a user, comprising the steps of:
receiving VOD program identification information from said user wherein said user is a subscriber of a cable service provider, wherein said VOD program identification information identifies a VOD program available for viewing by said user on a cable distribution network of said cable service provider;
generating a token value;
storing said token value in said memory;
using said token value to generate image data representing a visual token;
transmitting said image data representing said visual token to a computing display device of said user for display to said user;
receiving a second token value from a mobile device associated with said user, wherein said second token value is correlated with said token value;
receiving an alpha-numerical identification value received from said mobile device wherein said alpha-numerical identification value corresponds to previously stored alpha-numerical identification associated with said mobile device; and
causing said VOD program to be streamed to said user over a communications network that is not said cable distribution network.

15. The method of claim 14 further comprising the step of:
using said alpha-numerical identification value to identify a subscriber profile of said subscriber.

16. The method of claim 15 further comprising the steps of:
transmitting said alpha-numerical identification value to said mobile device.

17. The method of claim 16 wherein said alpha-numerical identification value is a cookie that is associated by said processor with said subscriber profile of said subscriber.

18. The method of claim 15 wherein said processor ascertains a rating of said VOD program is compatible with said service profile.

19. The method of claim 14 further comprising the steps of:
starting a timer prior to transmitting said visual token data from said processor; and
receiving said second token at said processor prior to said timer value exceeds a threshold.

20. The method of claim 14 where the step of determining in said processor that said second token value is associated with said token value is followed by a step of:
transmitting by said processor to said computing display device a confirmation that said VOD program is authorized for streaming to said user.
